(19) United States
(12) Patent Application Publication
(10) Pub. No.: US 2009/0184106 A1
(43) Pub. Date: Jul. 23, 2009

(54) FLEXIBLE PLANAR HEATING DEVICE

(76) Inventor: KUEI-HUANG WU, Taipei Hsien (TW)

Correspondence Address: LEONG C LEI, PMB # 1008, 1867 YGNACIO VALLEY ROAD, WALNUT CREEK, CA, 94598, US

(21) Appl. No.: 12/015,523

(22) Filed: Jan. 17, 2008

(51) Int. Cl. H05B 3/34; H01C 3/06

(52) U.S. Cl. 219/528; 338/210

(57) ABSTRACT

A heating device which includes two first conducting members and at least a second conducting member, wherein the first conducting members are made of silicone rubber conductor and flexibly pressed into an upper thin layer and a lower thin layer between which is arranged the second conducting member. The first and second conducting members are formed into a whole unit by heat and pressure, which are provided holes at predetermined positions for increasing the contact area to disperse electrical current and conducting wires for connection in parallel or series with the power source. Voltages from 0.1V˜500V AC or DC are all applicable. Hence, the first and second conducting members can dissipate heat evenly. The increased temperature ranges from 1˜230° C. with respect to the environmental temperature thereby preventing the formation of high temperature points. Furthermore, the holes can reduced the electrical current required.

### (a) TECHNICAL FIELD OF THE INVENTION

The present invention generally relates to heating devices, and more particularly to a flexible planar heating device whose heat producing members connect to a power source via a number of low-resistance members.

### (b) DESCRIPTION OF THE PRIOR ART

In conventional planar heating devices, conducting wires or rigid circuit boards are arranged across a planar heat-producing member so as to create a large warm area. The common drawbacks of these heating devices are that it takes a considerable amount of time for the heat-producing member to heat up, the heat is not evenly distributed, and the heating devices usually cannot be folded or bended.

Flexible planar heating devices using various types of fabrics as heat-producing members are disclosed, for example, in R.O.C. Taiwan Patent Nos. M257591 and M294805. These devices have their power cables connected to the heat-producing members via point contacts such as those by soldering or riveting. A high temperature is usually developed at these contact points, which would cause some protective covers to the heating device to catch fire and, therefore, presents a potential hazard to the user. Additionally, these protective covers could be easily peeled off after a period of usage and the heating device is therefore not properly insulated.

U.S. Pat. Nos. 7,115,844, 4,149,066, and 3,359,524 also teach planar heating devices yet with similar drawbacks described above. For example, the planar heating device of U.S. Pat. No. 7,115,844 has point contacts; and the heating devices of U.S. Pat. Nos. 4,149,066 and 3,359,524 would take a rather long time to heat up, suffer uneven heat distribution, and result in broken conducting wires after a period of usage.

The foregoing teachings further suffer additional drawbacks such as that they all consume a considerable amount of electricity, which is not quite environmentally friendly from today's standard, and that they are rather rigid to fit on various objects, and that their protective covers could easily be peeled off.

### SUMMARY OF THE INVENTION

Accordingly, a novel flexible planar heating device is provided herein that avoids the use of point contacts, reduces electricity consumption without sacrificing heating time, and achieves a substantially uniform heating.

To achieve these objectives, the heating device according to the present invention utilizes a number of linear, low-resistance conducting members sandwiched between two flexible heat-producing members. The linear conducting members function as intermediate media to the wires of a power cable. The large contact area between the linear conducting members and the heat-producing members prevents the development of high temperature at a few points. The linear conducting members, on the other hand, help distributing the electrical current to the heat-producing member so as to achieve shorter heating time and more uniform distribution of heat. In addition, a number of through openings distributed across the heat-producing members help lowering the electricity consumption with no noticeable effect to the user.

The heating device could be submerged in insulating ink and then thermally cured to form an insulating ink layer around the heating device to provide the required insulation. Alternatively, an insulating member could be coated on the heating device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a heating device according to an embodiment of the present invention.

FIG. 2 is a perspective exploded view showing the various components of the heating device of FIG. 1.

FIG. 3 is a front view to embodiments a, b, c, and d of the present invention.

FIG. 4 is a schematic view showing a first application of the present invention.

FIG. 5 is a schematic view showing a second application of the present invention.

FIG. 6 is a schematic view showing a third application of the present invention.

FIG. 7 is a schematic view showing a fourth application of the present invention.

FIG. 8 is a schematic view showing a fifth application of the present invention.

FIG. 9 is a schematic view showing a sixth application of the present invention.

FIG. 10 is a schematic section view showing a heating device according to another embodiment of the present invention.

FIG. 11 is a schematic section view showing a heating device according to yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

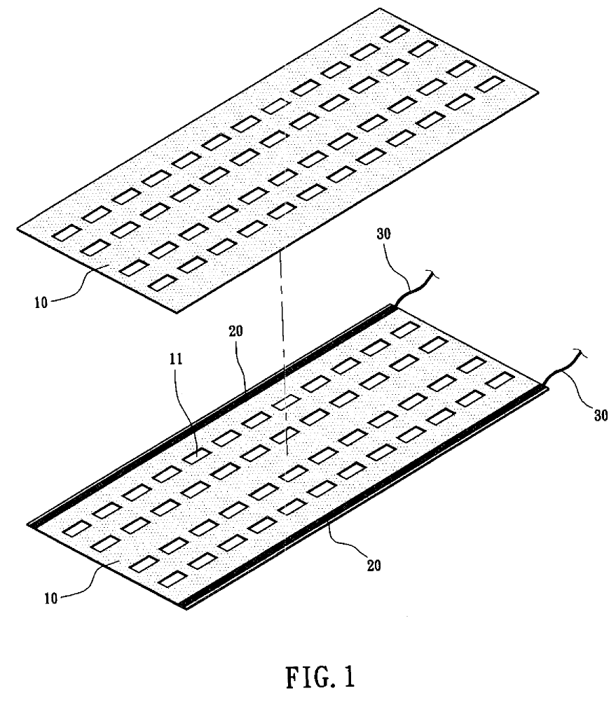

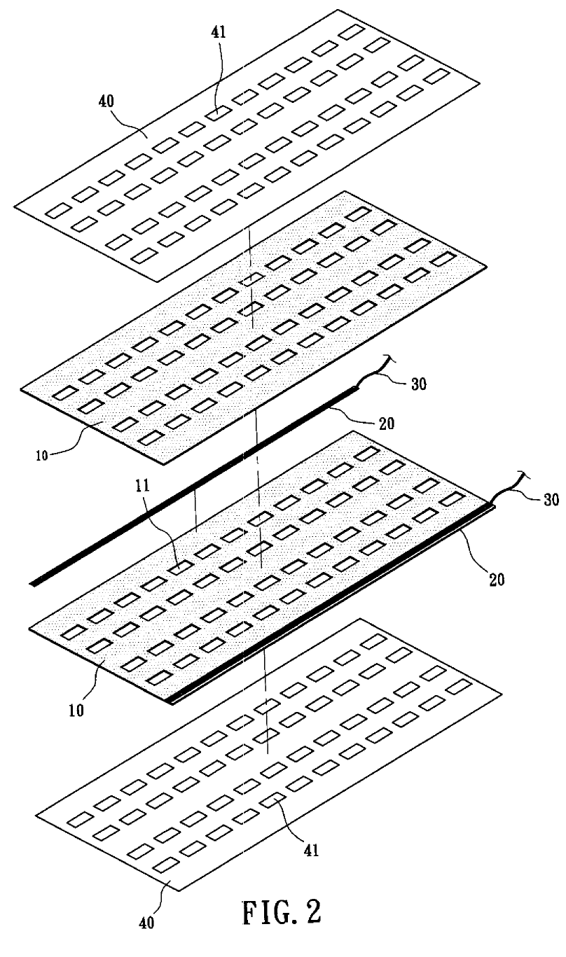

As shown in FIGS. 1 and 2, a planar heating device according to an embodiment of the present invention contains two flat first conducting members 10 capable of conducting electricity and producing heat, a number of flat and elongated second conducting members 20 capable of conducting electricity with low resistance sandwiched between the first conducting members 10, a number of conducting wires 30 each having at least an end connected to a second conducting member 20, two flat insulating members 40 having the first and second conducting members 10 and 20 sandwiched between. A number of through openings 11 are arranged across the first conducting members 10.

The first conducting member 10 is made of an electrically conducting rubber having a high resistance. The first conducting member 10 can have an appropriate planar shape and is not limited to the rectangular shape as illustrated. Preferably, the first conducting member 10 is made of silicone rubber conductor so that the first conducting member 10 can be flexibly pressed into a planar shape and cam be flatly arranged on a surface of an object. When electricity is introduced through the first conducting member 10, heat is produced from its high resistance. The openings 11 are provided to reduce the amount of electricity consumed. The openings 11 can also have appropriate shapes and sizes, and can be arranged across the first conducting member 10 in various ways. For example, as; shown in FIGS. 1 and 2, the openings 11 are arranged uniformly and regularly so as to achieve an even distribution of heat across the first conducting member 10. As the first conducting member 10 provides a large planar contact area, for example, to a user's skin, the comparatively smaller openings 11 do not introduce noticeable difference to the user.

The second conducting member 20 can be made of a rigid or flexible conducting material but with a resistance substantially smaller than that of the first conducting member 10. Preferably, the second conducting members 20 have resistances below one ohm. The second conducting members 20 can have a planar shape, a strip-like shape, or a wire-like shape. They can be integrally formed and embedded in the first conducting members 10 by the application of heat and pressure, or they can be flatly attached to the first conducting members 10. If the second conducting members 20 are made of a flexible material, it can be flexibly laid on an object's surface along with the first conducting members 10.

Each conducting wire 30 has at least one of its ends connected to a second conducting member 20. Two of the conducting wires 30 have the other ends connected to the positive and negative terminals of an external DC or AC power supply (not shown) so as to introduce electricity into the first conducting member 10 via the second conducting members 20. The voltage of the power supply could range from 0.1V to 500V. The temperature of the heating device could range from 1° C. to 230° C. relative to the environment.

The insulating members 40 can be made of a rigid or flexible insulating material such as non-woven fabric, silicon, and plastic film. The first conducting members 10, the second conducting members 20, and the conducting wires 30 interconnecting the second conducting members 20 are flatly sealed between the two insulating members 40. The insulating member 40 is, on one hand, to enhance the robustness of the heating device and, on the other hand, to prevent electrical short circuit or leakage of the first and second conducting members 10 and 20 if they are in direct contact with the object to be heated. For each opening 11 of the first conducting members 10, there are compatible and corresponding openings 41 on the insulating members 40.

For the heating device as described, using the second conducting members 20 as intermediate media between the conducting wires 30 and the first conducting members 10, due to the low resistance and large contact area of the second conducting members 20, leads to an even distribution of electrical current and a shorter heating time, and also prevents the produced heat from concentrating at a few points.

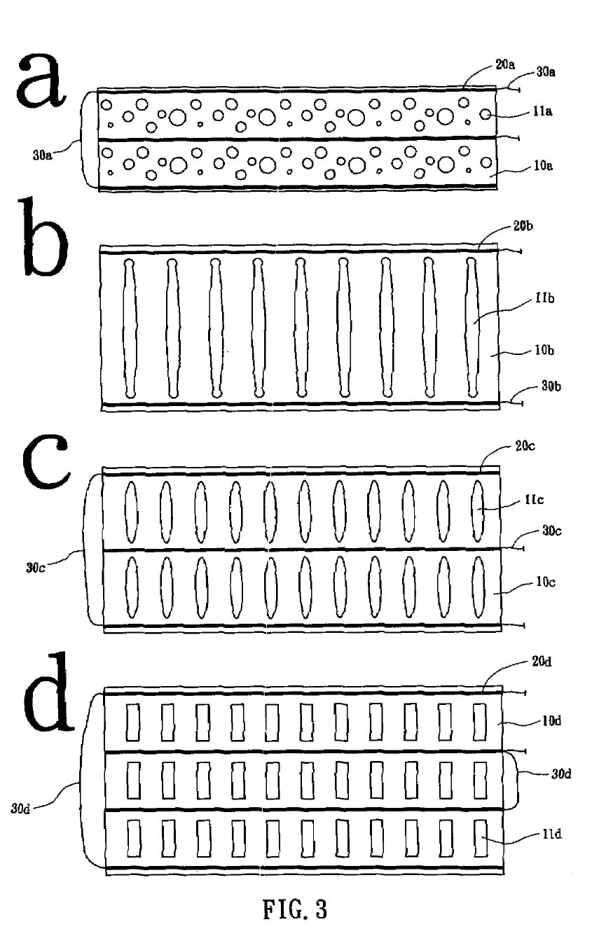

Four embodiments (namely, a, b, c, and d) of the present invention are shown in FIG. 3. As illustrated, the first conducting members 10a, 10b, 10c, and 10d can be of various sizes and the number (at least 2) and locations of the second conducting members 20a, 20b, 20c, and 20d can be appropriately selected and arranged so as to evenly distribute the electrical current and heat. Conducting wires 30a, 30b, 30e, and 30d, in addition to the introduction of electricity to the heating device, can be used to connect a number of the second conducting members 2D in series or in parallel. Please note that at least two second conducting members 20 should have a dangling end (i.e., not connecting to the conducting wires 30). The sizes and shapes and locations of the openings 11a, 11b, 11c, and 11d can also be appropriately selected and arranged.

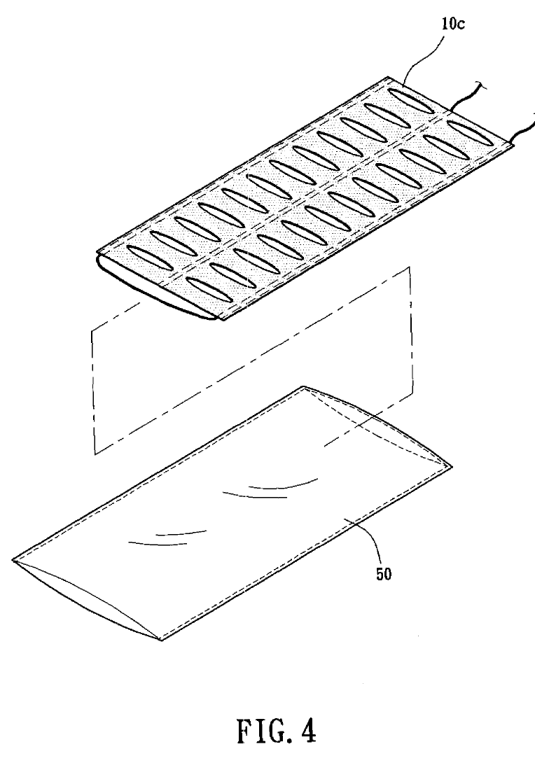

FIG. 4 shows an application of the present invention. As illustrated, a heating device of the present invention is sleeved into and stitched to, for example, a pillowcase so as to keep a user's head warm. Please note that, in this application and those that follow, the openings of the first conducting member are flexibly arranged in accordance with the intended application.

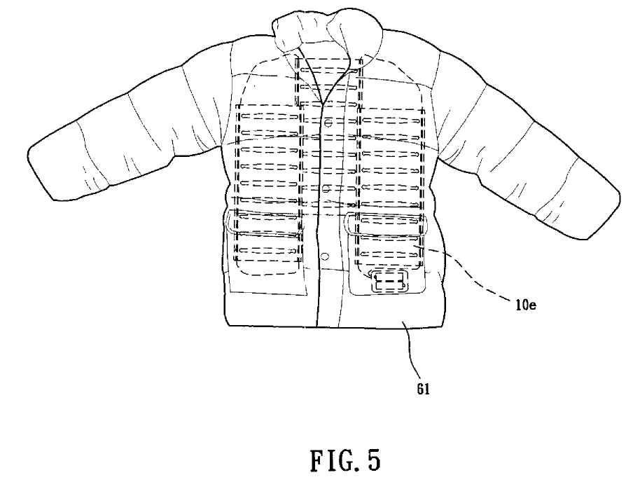

FIG. 5 shows another application of the present invention. As illustrated, since the first conducting members 10e can have an appropriate shape and the openings can be flexibly arranged, the heating device can be embedded in a coat 61 so as to keep a user warm.

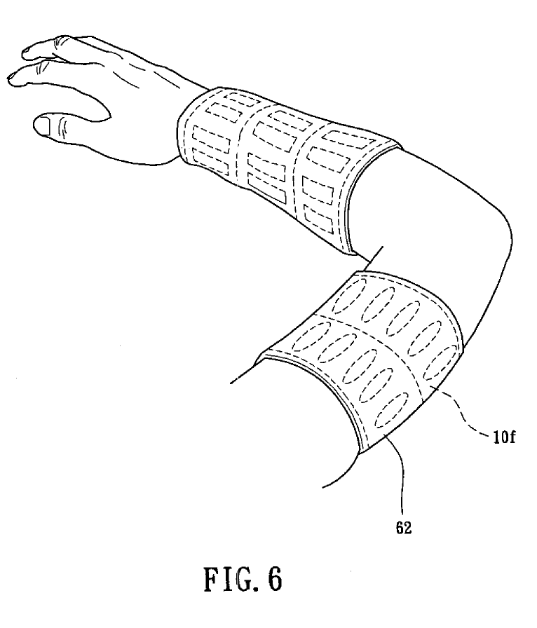

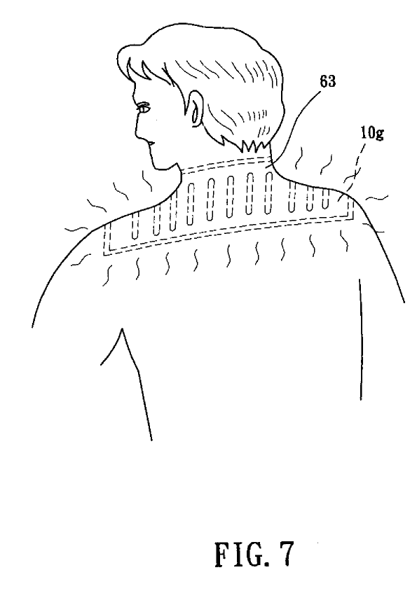

Similarly, as shown in FIG. 6, a heating device having cylindrical first conducting members 10f can be embedded in an arm band 62 for fomentation to a user's arm. Similarly, in FIG. 7, a heating device having first conducting members 10g of a special shape can be embedded in a pad 63 for fomentation to a user's upper back.

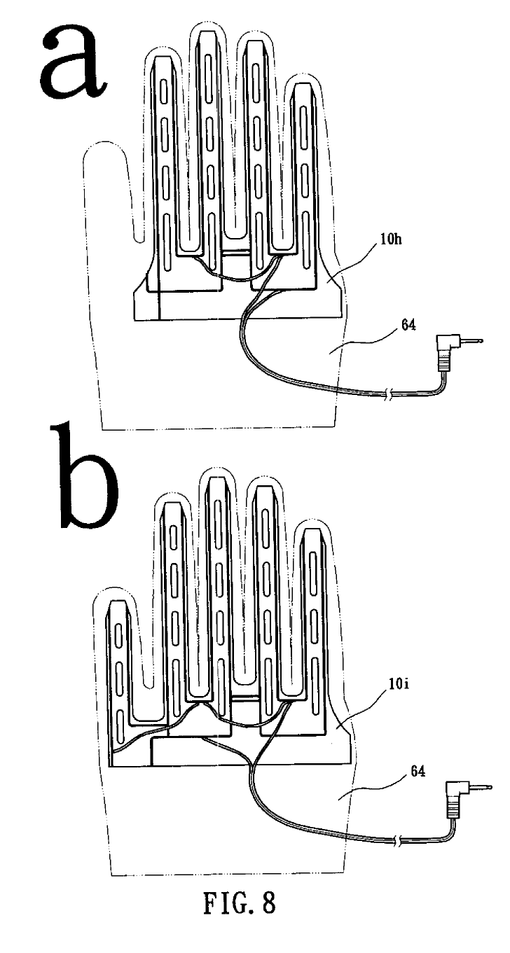

FIG. 8 shows another embodiment of the present invention. Two heating devices having first conducting members 10h and 10i with shapes conforming to the right and left hands, respectively, are embedded in a pair of gloves 64 to keep a user's both hands warm. Please note that the conducting wires of each heating device are equipped with a plug (not numbered) for connecting to, for example, a battery.

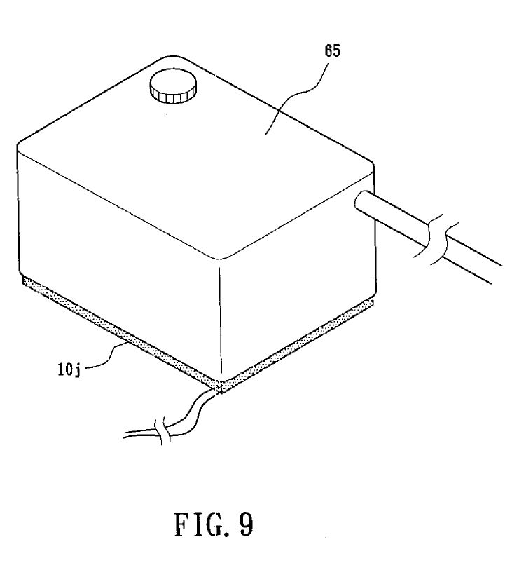

As illustrated in FIG. 9, a heating device with first conducting members 10j is attached to the outside of the gas tank or water tank of an automobile so as to prevent the gasoline or water from freezing during cold winter.

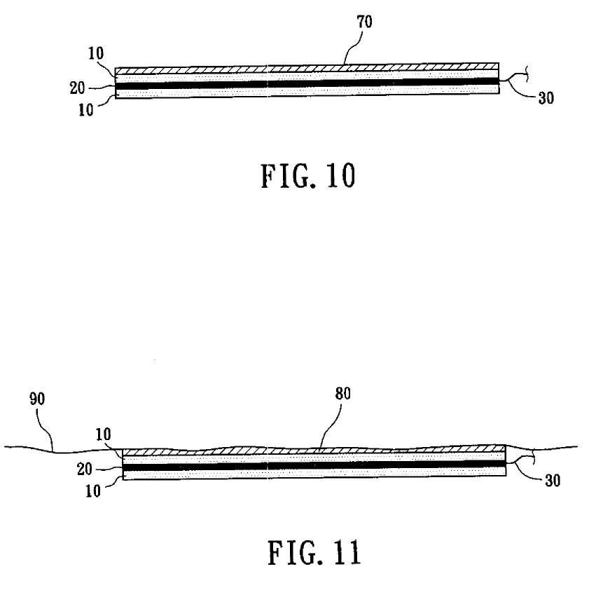

As illustrated in FIG. 10, a heating device of the present invention could have an outside surface of a first conducting member 10 submerged in or coated with insulating ink and then have the insulating ink thermally cured to form an insulating ink layer 70, instead of using the insulating member 40.

As illustrated in FIG. 11, a heating device of the present invention could have an outside surface of a first conducting member 10 coated or applied with hot melt adhesive 80 so as to attach the heating device to an object. Alternatively, the hot melt adhesive 80 could be applied on the surface of the object first and then the heating device is pressed to the hot melt adhesive 80 under a high temperature. The hot melt adhesive 80 not only provides insulation but also provides reliable adhesion of the heating device to the object.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A flexible planar heating device, comprising:
two flat and flexible first conducting members made of silicone rubber conductor;
a plurality of flat and linear second conducting members made of a low-resistance conducting material integrally formed with and sandwiched between said first conducting members; and
two conducing wires connecting two separate second conducting members to a DC or AC power supply ranging from 0.1V to 500V, respectively;
wherein said heating device produces a temperature ranging from 1° C. to 230° C. relative to the environment.

2. The flexible planar heating device according to claim 1, wherein said first conducting members have a plurality of distributed through openings.

3. The flexible planar heating device according to claim 2, wherein said through openings of said first conducting members have an appropriate geometric shape.

4. The flexible planar heating device according to claim 2, wherein said through openings of said first conducting member are distributed substantially uniformly across said first conducting member.

5. The flexible planar heating device according to claim 2, wherein said through openings of said first conducting member are distributed irregularly across said first conducting member.

6. The flexible planar heating device according to claim 1, further comprising two flat insulating members wherein said first conducting member and said second conducting members are sandwiched and sealed between said insulating members.

7. The flexible planar heating device according to claim 6, wherein said insulating members have a plurality of through openings compatible to and located correspondingly to said through openings of said first conducting member.

8. The flexible planar heating device according to claim 1, further comprising at least an interconnecting conducing wire connecting two second conducing members in series.

9. The flexible planar heating device according to claim 1, further comprising at least an interconnecting conducing wire connecting two second conducing members in parallel.

10. The flexible planar heating device according to claim 1, wherein said heating device is installed in a bag so that said bag has a heating capability.

11. The flexible planar heating device according to claim 1, wherein said heating device is installed to an appropriate object so that said object has a heating capability.

12. The flexible planar healing device according to claim 1, wherein at least one of said first conducting members has an insulating ink layer on an outside surface of said first conducting members.

13. The flexible planar heating device according to claim 1, wherein at least one of said first conducting members is attached to an appropriate object by hot melt adhesive.
